(19) United States
(12) Patent Application Publication
(10) Pub. No.: US 2007/0073766 A1
(43) Pub. Date: Mar. 29, 2007

(54) System, Method, and Computer-Readable Medium for Mobile Media Management

(75) Inventor: Todd M. PORTER, Dallas, TX (US)

Correspondence Address: HAYNES AND BOONE, LLP, 901 MAIN STREET, SUITE 3100, DALLAS, TX, 75202, US

(73) Assignee: DIVERSIFIED MULTIMEDIA, LLC, Dallas, TX (US)

(21) Appl. No.: 11/536,484

(22) Filed: Sep. 28, 2006

Related U.S. Application Data
(60) Provisional application No. 60/721,256, filed on Sep. 28, 2005.

(51) Int. Cl. G06F 17/00

(52) U.S. Cl. 707/103 R

(57) ABSTRACT

A system, method, and computer-readable medium for mobile media management is provided. A user may capture media content on a media device. The captured media content may automatically be uploaded to a management server. Other users may access the uploaded media content from a variety of media devices. The media content may be automatically deleted from the device used to acquire the media content thereby freeing memory capacity on the acquiring device. The user of the device used to acquire the media content may access the uploaded media content from any of a variety of media devices. Distribution of media content acquired by a media device may be made to other users that have been designated as authorized to view the user's media content.

### RELATED APPLICATION DATA

This patent application claims the benefit of provisional U.S. Patent Application Ser. No. 60/721,256, filed Sep. 28, 2005.

### BACKGROUND

With the proliferation of mobile camera phones, digital cameras and video cameras, consumers of these devices are generating a large quantity of photographs and video content. However, these consumers face a challenging task when they want to transfer, print, download and otherwise access and manage various digital media content. Media content captured by digital cameras, camcorders, and the like are often at risk of being accidentally erased or lost, e.g., when a camera or its memory card malfunctions. Today, there is no easy way to manage, archive, make prints, make CD/DVD copies, and share captured digital multimedia content.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified schematic diagram of an embodiment of a system for mobile multimedia management;

FIG. 2 is a simplified block diagram of an embodiment of a mobile device operable to acquire multimedia content;

FIG. 3 is a simplified block diagram of an embodiment of a device operable to acquire multimedia content retrofitted with a custom chip or chipset with memory, wireless communication, and operating system functionality for mobile multimedia management;

FIG. 4 is a diagrammatic representation of a media repository table of the media repository depicted in FIG. 1 that facilitates management of media content in accordance with an embodiment;

FIG. 5 is a diagrammatic representation of an entry of a distribution list that facilitates media synchronization in accordance with an embodiment;

FIG. 6A is an exemplary message flow diagram of the system and method for mobile multimedia management implemented in accordance with embodiments;

FIG. 6B is an exemplary message flow diagram of a media content distribution routine implemented in accordance with an embodiment;

FIG. 7 is a flowchart depicting an upload routine that may be executed by a management server for storing content uploaded by media devices in accordance with an embodiment; and

FIG. 8 is a flowchart that depicts processing of a synchronization routine for distributing media content to media devices in accordance with embodiments disclosed herein.

### DETAILED DESCRIPTION

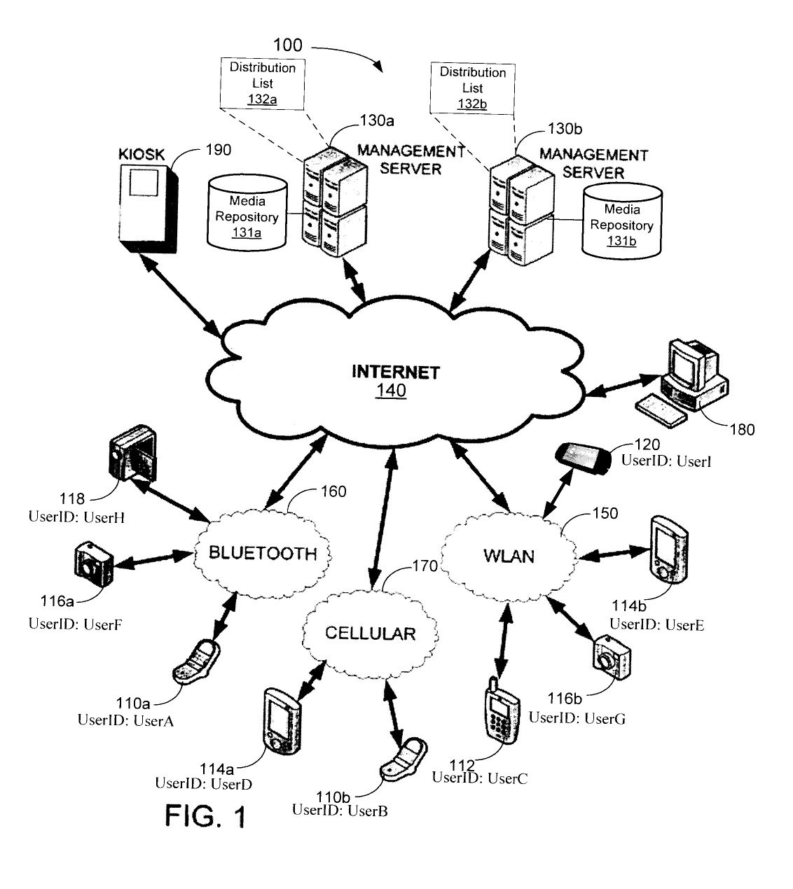

FIG. 1 is a simplified schematic diagram of an embodiment of a system 100 for mobile multimedia management. System 100 enables a variety of different consumer devices to be able to transfer, view, download, upload, and synchronize media content. Consumer devices that may include functionality to capture media content include, for example, mobile phones 110a-110b, smart phones 112, personal digital assistants (PDAs) 114a-114b, digital cameras 116a-116b, digital video cameras 118, personal gaming devices, 120 such as the PlayStation™ portable (PSP), etc. (collectively referred to herein as mobile media devices). Users of media devices may have a user identifier (UserID) or other identifier associated therewith. In the illustrative example, users of devices 110a-120 have a respective UserID of UserA-User1. These mobile media devices may be in communication with a management server 130a-130b (collectively referred to as management server 130) via, for example, the Internet 140 and/or some other network mechanisms, such as a wireless local area network (WLAN) 150 which may comprise a WiFi network, a Bluetooth network 160 or other personal area network, a cellular network 170 or another mobile network, or another suitable communications system.

Management servers 130a-130b may include or interface with a media content repository 131a-131b (collectively referred to herein as content repository 131). Content repository 131 may comprise a database or other suitable data structure maintained on a storage medium, such as a hard disk, in which media content uploaded to management server 130 from one or more various media devices is stored. Additionally, content repository 131 may include timestamps assigned to media content that is stored thereby to facilitate synchronization between various devices as described more fully hereinbelow. Management servers 130 may also include or interface with a distribution list 132a-132b (collectively referred to as a distribution list 132). Distribution list 132 may include an identifier of a media device, or a user thereof, and other users the user of the media device wishes to share media content with.

The consumer devices may be operable to connect to Internet 140 via multiple wireless communications mechanism, and the one with the most available bandwidth and/or fastest speed may be selected for a data transfer session. In other implementations, a consumer device may directly connect with Internet 140, e.g., via an Internet service provider. In some implementations, the media devices may be in communication with a computing device 180 such as a computer that may be used to output prints, burn CD/DVD, and perform other tasks. The users of the system may be identified by unique IDs, such as a user name, device ID, device MAC address, and/or other identifiers, and communication sessions and transferred content may be marked or otherwise identified with a user. Security mechanisms are in place to provide only authorized users access to the media content of a user. Passwords and other mechanisms may be used.

The system may also include a kiosk 190. Kiosk 190 may provide an interface with a consumer located at various locations, such as retail locations, airports, hotels, resorts, amusement parks, or other convenient locations. Kiosk 190 may include a computing device, a display screen that may be touch-sensitive and user input devices such as a keyboard, pointing device, etc. Kiosk 190 may have a reader that accepts a variety of memory flash cards to quickly transfer captured media content therein to an internal memory of kiosk 190. The transferred content may be marked with user identification information that has been encoded on the memory flash card so that the multimedia content may then be uploaded to a management server 130. The user may also use an identification card with a computer-readable code such as a bar code, a magnetic strip, a smart chip or some other device that enables kiosk 190 to label or mark the transferred content as belonging to a specific user account. Kiosks may be used in areas where cellular service is spotty and other wireless LAN service is absent or limited.

System 100 may include a phone-resident photo/video manager which has the ability to automatically communicate, synchronize and deliver digital media content to a management server 130, and the ability to enable users to view photos/videos off management server 130. System 100 may also include a computing device-resident photo/video manager which has the ability to automatically communicate, synchronize and deliver digital media content to management server 130, and the ability to view photos/videos off management server 130. Multimedia content downloaded to the computing device 180, e.g., a PC, workstation, laptop, server, or other suitable device, may be printed, copied onto CD/DVD, edited, or otherwise manipulated and processed. Similarly, media content imported, e.g., from a camera, video camera, scanner, CD, DVD, or the Internet), into computing device 180 may be uploaded to management server 130 and/or output in a number of print or digital formats. The phone-resident manager and the computing device-resident managers enable a synchronization or download of digital media content stored on management server 130 to the respective devices. A synchronization process is operable to compare various media content at management server 130 to the content stored at a computer, for example, and to synchronize the two so that the content mirror each other. A download may be made with respect to certain particular media files, timestamp of the media files, or some other method of specifying a subset of media content to transfer to the device, such as a mobile phone or PSP. The upload, download and synchronizing are performed automatically and transparently without user initiation or request. Multiple management server 130a-130b may be deployed in clusters in order to service all the consumers' needs and/or to provide for fault tolerance. Further, management servers 130 may have one or more mirrored management servers that serve as backup storage copies of an active management server.

Therefore, photos, videos, or other media content may be automatically duplicated onto management server 130. In one embodiment, if a media capture device such as a mobile phone is off, when it is turned back on, management server 130 may automatically be called and media content transfers may then be made. The user may select to automatically delete media content once transfer is made to free up memory on the capture device. Media content may be stream-viewed on a capture device, and media content may be downloaded and viewed on the mobile phone. All media content may be archived on management server 130.

System 100 may provide various benefits to users. For example, users are provided with a seamless way to transfer their media content to and from their media capture devices, and system 100 provides users with a secure storage place for their media content. Additionally, users have access to their entire collection of media content on-the-go. For example, existing mobile phones with media content capture functionality may have a phone-resident management client added, and existing mobile phones and PCs may receive or otherwise obtain a client to access media content stored on management server 130.

System 100 may include additional servers, clients, and other devices not shown. In the depicted example, Internet 140 represents a worldwide collection of networks and gateways that use the Transmission Control Protocol/Internet Protocol (TCP/IP) suite of protocols to communicate with one another. FIG. 1 is intended as an example, and not as an architectural limitation, of a network system in which embodiments disclosed herein may be deployed.

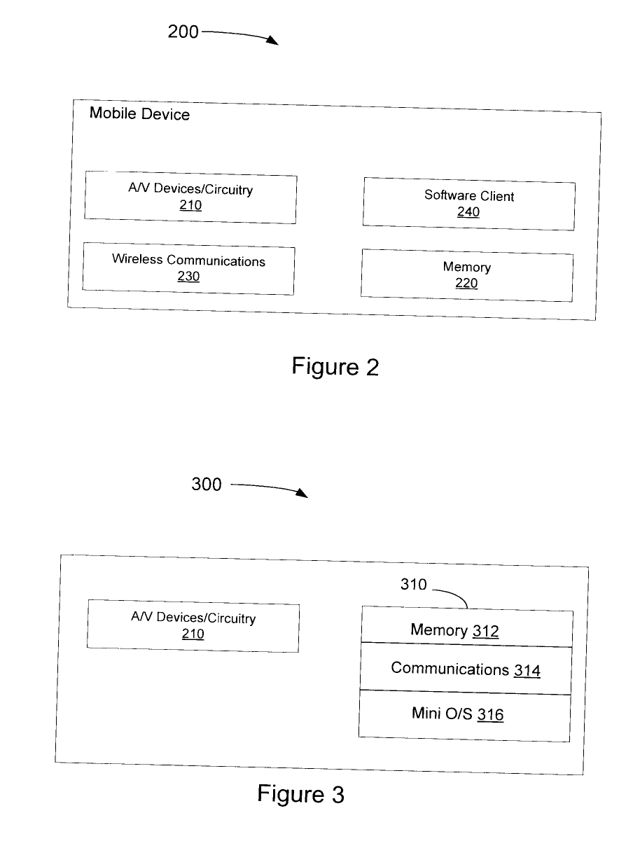

FIG. 2 is a simplified block diagram of an embodiment of a mobile device 200 operable to acquire media content. For example, mobile device 200 may be a mobile phone 110a-110b, smart phone 112 equipped with a camera, PDA 114a-114b, video camera 118, or other device adapted to capture media content. Mobile device 200 may comprise audio/video capture and/or playback devices and circuitry 210 such as digital camera/video optical devices and circuitry for capturing still and/or video images, a memory device 220 for storing captured images or other media content, and wireless communication module 230 that may include hardware, firmware, software, or a combination thereof. Additionally, mobile device 200 may include a software thin client 240 that includes phone-resident management software that enables the content captured by mobile device 200 to be automatically uploaded to management server 130. In accordance with an embodiment, the user of device 200 will not need to initiate the upload process, but rather the upload process may be invoked automatically. In one implementation, as soon as new media content is discovered in the device's memory, the upload is initiated. Mobile device 200 may also automatically synchronize with management server 130 or instruct management server 130 to download particular media content.

FIG. 3 is a simplified block diagram of an embodiment of a device 300 retrofitted with a custom chip or chipset 310 with memory 312, a wireless communication module 314 comprising hardware, firmware, software, or a combination thereof, and an operating system 316 for general device hardware and software management and mobile media management. Device 300 is operable to acquire media content in accordance with embodiments disclosed herein. Device 300 may comprise a digital camera, a digital video recorder, or some other device that is not manufactured with wireless communication capabilities, but rather is adapted with wire communication capabilities via retrofitting device 300 with chipset 310. The custom chip or chipset 310 may be a replacement of a memory card used in mobile device 300 or may be incorporated into an existing mobile device in some other manner. The mini operating system (O/S) 316 may manage media content on device 300, automatically initiate content upload, download and synchronization with management server 130, and other functions. Alternatively, media management functionality may be provided by an application running on O/S 316.

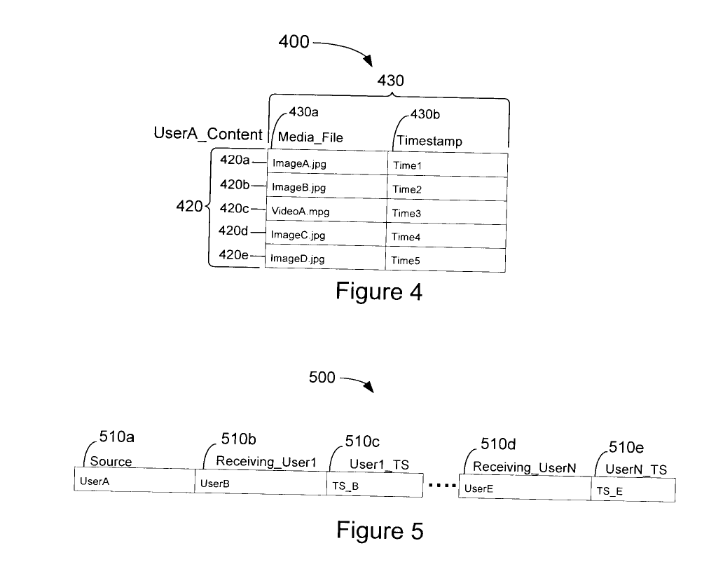

FIG. 4 is a diagrammatic representation of a media repository table 400 of media repository 131 depicted in FIG. 1 that facilitates management of media content in accordance with an embodiment. Table 400 records identifiers, such as file names, of content captured by a media device and uploaded to management server 130 with timestamp data. Additionally, table 400 may associate an identifier of the user that uploaded the content identified by table 400.

In the illustrative example, table 400 comprises a plurality of records 420a-420e (collectively referred to as records 420) and fields 430a-430b (collectively referred to as fields 430) in which media content identifiers uploaded from a device associated with a particular user is stored. Table 400 may be stored on a disk drive or other suitable medium, fetched therefrom by a processor or other instruction processing device, and processed by a data processing system such as management server 130 depicted in FIG. 1.

Table 400 may have a label, or identifier, such as a file name that facilitates media management implemented in accordance with an embodiment. In the illustrative example, table 400 has a label of UserA_Content. Thus, table 400 is representative of a data structure that may maintain records of media content uploaded by phone 110a associated with a user having a UserID of UserA.

Fields 430 have a respective label, or identifier, that facilitates insertion, deletion, querying, or other data operations or manipulations of content thereof. In the illustrative example, fields 430a-430b have respective labels of Media_File and Timestamp. Each record 420a-420e defines a respective media content file identifier, e.g., filename, and a corresponding timestamp at which media content specified in field 430a of a corresponding record of table 400 was uploaded to management server 130.

In the illustrative example, data elements stored in Media_File field 430a comprise media identifiers of a particular media content uploaded to management server 130 from a device associated with the user having a UserID of UserA. Data elements of Media_File field 430a may, for example, specify an image file name, a multimedia file name, an audio file stream, or the like. In the present example, Media_File labels of media content uploaded to management server 130 by the user having a userID of UserA are illustratively designated ImageA.jpg, ImageB.jpg, VideoA.mpg, ImageC.jpg, and ImageD.jpg. Timestamp field 430b comprises timestamps that specify a time at which a media file identified by Media_File field 430a of a corresponding record were uploaded from a media device to management server 130. In the present example, times at which media files identified in Media_File field 430a were uploaded to management server 130 are illustratively designated Time1-Time5. Data structures similar to that depicted in FIG. 4 may be maintained or interfaced by management server 130 for other users that have uploaded media content to management server 130.

FIG. 5 is a diagrammatic representation of an entry 500 of distribution list 132 depicted in FIG. 1 that facilitates media synchronization in accordance with an embodiment. Entry 500 associates user identifiers of users with which a source user wishes to share media content in accordance with embodiments. Additionally, entry 500 may associate timestamp data with users to indicate a most recent synchronization of a device associated with the respective user.

In the illustrative example, entry 500 comprises a record with various fields 510a-510e (collectively referred to as fields 510). Entry 500 defines a distribution list of users that may have media content synchronized with another user. Entry 500 may be stored on a disk drive or other suitable medium, fetched therefrom by a processor or other instruction processing device, and processed by a data processing system such as management server 130 depicted in FIG. 1. Distribution list 132 may have a plurality of entries similar to entry 500 each allocated for a particular user. For example, distribution list 132 may be implemented as a table with distribution list entries maintained as records thereof.

Fields 510 have a respective label that facilitates insertion, deletion, querying, or other data operations or manipulations of content thereof. In the illustrative example, fields 510a-510e have respective labels of Source, Receiving_User1, User1_TS, Receiving_UserN, and UserN_TS. Entry 500 defines a distribution list of a particular source or user specified in Source field 510a. Thus, in the illustrative example, entry 500 defines a distribution list for the user having a UserID of UserA, i.e., the user assigned to phone 110a depicted in FIG. 1.

In the present example, one or more fields 510b and 510d may specify a respective user that may be allowed to synchronize media content captured and uploaded to management server 130 by the source user specified in Source field 510a. In the present example, fields 510b and 510d specify users having respective UserIDs of UserB and UserE that may be allowed to obtain and synchronize media content captured and uploaded by the user having a UserID of UserA specified in Source field 510a.

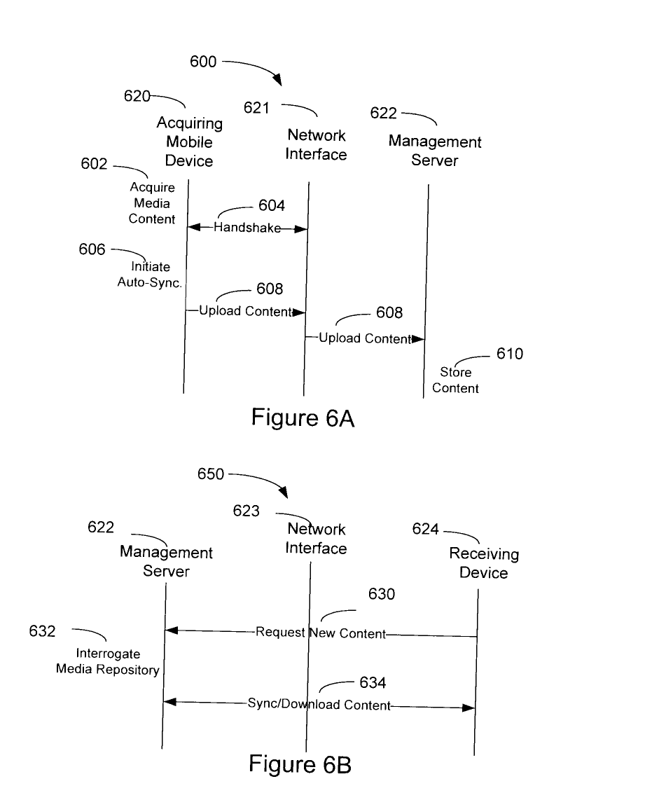

Each field identifying a particular user that may download media content uploaded by the source user specified in entry 500 may have an accompanying timestamp that specifies the most recent, if any, time at which the user downloaded the media content uploaded by the source user. In the present example, fields 510c and 510e specify timestamps illustratively designated TS_B and TS_E thereby indicating that the most recent time at which the users having UserIDs UserB and UserE downloaded content provided by the user UserA was at a time “TS_B” and “TS_E”. The timestamp values specified by the timestamps in fields 510c and 510e may specify a date including the year, month, and day, and a time at which the most recent download was made by the associated user. Thus, entry 500 specifies that media content uploaded by the user UserA may be downloaded by the users having UserIDs of UserB and UserE. Of course, the source user may also download content uploaded thereby. FIG. 6A is an exemplary message flow diagram 600 of the system and method for mobile media management implemented in accordance with an embodiment. Message flow diagram 600 depicts an exemplary routine for automatically uploading acquired content by, for example, a mobile device adapted to capture media content.

The routine may be invoked upon the acquisition of media content (step 602), e.g., such as acquisition of one or more pictures, video, audio, or other media content, by an acquiring mobile device 620. A device-resident media manager, e.g., a photo/video manager, may detect the acquisition of the media content and invoke a handshake routine over a network interface 621 (step 604). Network interface 621 may, for example, comprise a Bluetooth interface, a cellular network interface, or other wireless network interface. Upon completion of the handshake, an auto-synchronization routine may be initiated (step 606), and the newly acquired media content may then be uploaded to a management server 622 (step 608), such as management server 130 depicted in FIG. 1. Uploading of the media content may be made via one or more wireless networks, such as a WiFi network, cellular network, or other suitable wireless network infrastructure, and may be conveyed from the wireless network to management server 622 by Internet 140. On receipt of the uploaded content by management server 622, management server 622 may store the content (step 610).

In one embodiment, the acquiring device 620 may include an identifier, e.g., of a user associated with device or a device identifier assigned to device 620, that may be used to associate the particular user with the acquired content. Accordingly, management server 622 may store the uploaded media content in association with the user identifier or a device identifier from which a user assigned to the acquiring device may be resolved.

FIG. 6B is an exemplary message flow diagram 650 of a media content distribution routine implemented in accordance with an embodiment. Message flow diagram 650 depicts an exemplary routine for distributing content acquired by a mobile device to other devices.

A receiving device 624, such as a mobile phone, PDA, computing device, or other data processing system, may issue a request for new content from management server 622 (step 630). The request may be conveyed over a suitable network interface, such as an interface with a cellular network, WiFi network, or other suitable medium, and may be conveyed therefrom via Internet 140 to management server 622. In one implementation, the request may include an identifier associated with the user of the receiving device 624. Additionally, the request may include an identifier of the media content, if any, currently maintained by receiving device 624. In one implementation, the receiving device 624 may include a timestamp that indicates the most recent time receiving device 624 has been provided with media content. Management server 622 may interrogate a media content repository with the user identifier associated with receiving device 624 to determine any users with which the user of device 624 is associated (step 632). Upon determining that the user of receiving device 624 is associated with an acquiring device that has provided content to management server 622, management server 622 may resolve the particular content to be delivered to receiving device 624 such that receiving device 624 has the most recent media content acquired by the acquiring device. The media content may then be downloaded to the receiving device 624 (step 634).

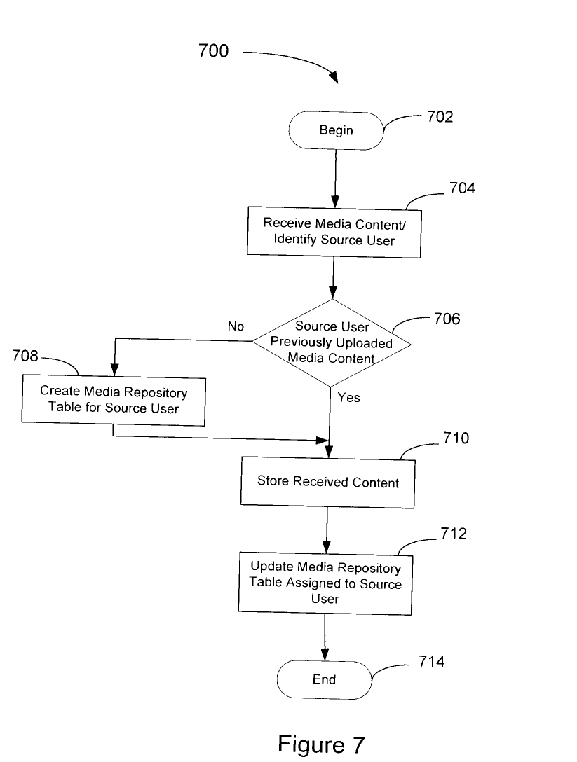

FIG. 7 is a flowchart 700 depicting an upload routine that may be executed by management server 130 for storing content uploaded by media devices in accordance with an embodiment.

The upload routine is invoked (step 702), and the management server receives uploaded media content from a media device (step 704). The media content uploaded by a source media device may have a UserID associated therewith. The management server may then evaluate whether the user of the source device, i.e., the source user, has previously uploaded media content to management server 130 (step 706). In the event that the source user has not previously uploaded media content, the upload routine may then create a media repository table similar to that depicted in FIG. 4 or other suitable data structure for the source user (step 708), and the upload routine may proceed to store the received media content (step 710).

Returning again to step 706, in the event that the source user has previously uploaded media content to the management server, the upload routine may proceed to store the received media content according to step 710. The media repository table assigned to the source user may then be updated to reflect the newly uploaded media content (step 712). For example, a new record may be added to the media repository table assigned to the source user that species the media content file and may have a timestamp associated therewith indicating the time at which the newly acquired media content was uploaded to management server 130. The upload routine cycle may then end (step 714).

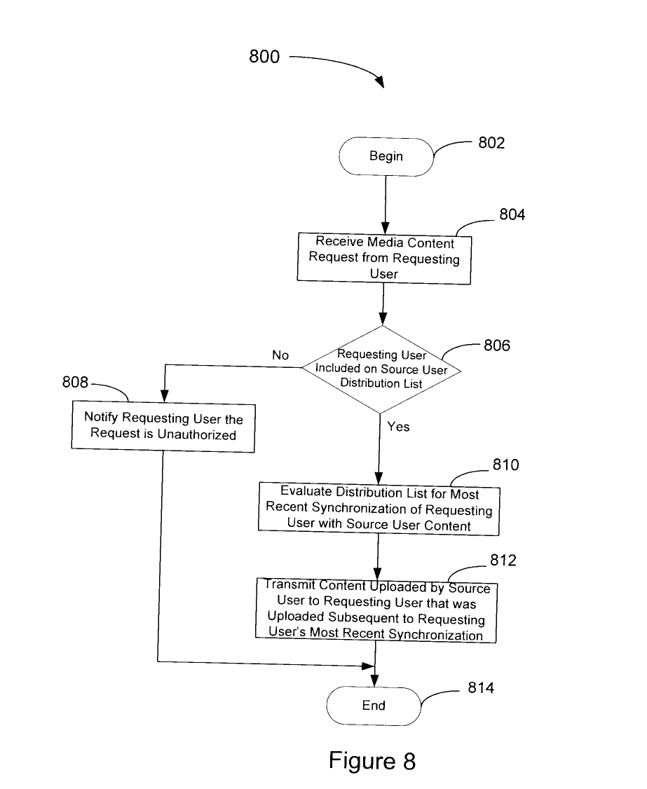

FIG. 8 is a flowchart 800 that depicts processing of a synchronization routine for distributing media content to media devices in accordance with embodiments disclosed herein.

The synchronization routine is invoked (step 802), and a request for media content is received from a requesting or receiving user device (step 804). In one embodiment, the request for media content may include a UserID of a media content source user the requesting user wishes to be synchronized with. The synchronization routine may then evaluate whether the requesting user is included in the source user's distribution list (step 806). If the requesting user is not included in the source user's distribution list, a notification that the requesting user is unauthorized to obtain media content uploaded by the source user specified in the request may be transmitted to the requesting user device (step 808), and the synchronization routine cycle may then end (step 814).

Returning again to step 806, in the event that the requesting user is included in the distribution list of the source user specified in the media request, the synchronization routine may then evaluate the distribution list of the source user for the most recent synchronization time of the requesting user (step 810). The synchronization routine may then transmit to the requesting user device any content that is identified as having been uploaded by the source user device since the most recent synchronization of the requesting user device (step 812). The synchronization routine cycle may then end according to step 814.

In other implementations, the request for content issued to management server 130 by a device may not include an identifier of a particular source user. Rather, management server 130 may interrogate distribution list 132 with the requesting UserID to identify any source users that have designated the requesting user as authorized to view the source user's content. In this implementation, any content uploaded by one or more, if any, source user's that have designated the requesting user as authorized to view content uploaded thereby may then be transmitted to the requesting user. Additionally, timestamps of content of any one or more source users that have designated the requesting user as authorized to view content uploaded thereby may be evaluated such that only content uploaded since the requesting user's most recent synchronization is transmitted to the requesting user similar to that described with reference to FIG. 8.

Embodiments disclosed herein may better be understood with reference to the following examples. Assume UserA takes pictures with phone 110a. The pictures begin automatically uploading to management server 130 after UserA takes the pictures. Further assume that UserA has designated UserB as a valid receiver of UserA's content. UserB may then turn on phone 110b and login to management server 130 to check for any new pictures acquired by UserA using the phone-resident management software on phone 110b. In this instance, pictures captured from UserA may then be downloaded to phone 110b for viewing by UserB. Other users' content may also be downloaded to phone 110b via management server 130 if UserB is designated as a valid receiver of other user's content.

UserA may additionally have PC-resident management software on UserA's PC, e.g., computing device 180 depicted in FIG. 1. In this instance, UserA may access management server 130 from computing device 180, download the newly acquired content taken with phone 110a, and, for example, burns a photo CD of the newly acquired pictures, print pictures on a printer connected with computing device 180, or otherwise retrieve and process, at computing device 180, content acquired with phone 110a.

Accordingly, pictures taken by a user may be automatically uploaded to management server 130 for retrieval by the user via other devices that may be located at various locations. Furthermore, distribution of media content acquired by a media device may be made to other users that have been designated as authorized to view the user's media content. In one implementation, media content may be automatically deleted from a device on which the media content was acquired as soon as the newly acquired content is uploaded to management server 130 thereby freeing up memory.

The flowcharts of FIGS. 7 and 8 depict process serialization to facilitate an understanding of disclosed embodiments and are not necessarily indicative of the serialization of the operations being performed. In various embodiments, the processing steps described in FIGS. 7 and 8 may be performed in varying order, and one or more depicted steps may be performed in parallel with other steps. Additionally, execution of some processing steps of FIGS. 7 and 8 may be excluded without departing from embodiments disclosed herein. The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, network stack, or any combination thereof, executing on a single computer processor or multiple computer processors. Additionally, various steps of embodiments of the invention may provide one or more data structures generated, produced, received, or otherwise implemented on a computer-readable medium, such as a memory.

Although embodiments of the present disclosure have been described in detail, those skilled in the art should understand that they may make various changes, substitutions and alterations herein without departing from the spirit and scope of the present disclosure.

What is claimed is:

1. A system comprising:
a management server;
at least one consumer device comprising:
a communications device enabling electronic communication with the management server;
a memory operable to store media content; and
a client application operable to automatically initiate and transfer media content stored in the memory to the management server.

2. The system of claim 1, wherein the client application is further operable to automatically initiate and synchronize media content stored in the memory with media stored at the management server.

3. The system of claim 1, wherein the client application is further operable to automatically initiate and download media content from the management server to the memory.

4. The system of claim 1, wherein the communications device is operable to communicate in a wireless manner to the management server.

5. The system of claim 1, wherein the communications device is operable to select an optimal communicate method from among a variety of wireless communication methods.

6. The system of claim 1, wherein the consumer device comprises a device operable to replace an existing memory card and further operable to provide memory functionality, wireless communication functionality, and operating system functionality.

7. A method comprising:
receiving an automatically-initiated media content transfer from a consumer device;
identifying the owner of the transferred media content;
storing the transferred media content to a memory;
restricting access to the transferred media content in the memory to approved users.

8. A method comprising:
receiving an automatically-initiated media content synchronization with a remote device;
identifying the requester of synchronization;
enabling access to media content upon determining the requestor is authorized to access the media content;
transmitting the media content to the requester.

9. A computer-readable medium having computer-executable instructions for execution by a processing system, the computer-executable instructions for managing media content, comprising:
instructions that receive a request for access to media content acquired by a first device of a first user;
instructions that determine an identity of a second user associated with a second device that issued the request;
instructions that determine whether the second user is authorized to access the media content; and
transmitting the media content to the second device.
